(19) United States
(12) Patent Application Publication
(10) Pub. No.: US 2026/0025268 A1
(43) Pub. Date: Jan. 22, 2026

(54) APPARATUS AND METHOD FOR PROVISIONING A SECURITY KEY FOR VEHICLE CONTROL

(71) Applicants: HYUNDAI MOTOR COMPANY, Seoul (KR); KIA CORPORATION, Seoul (KR); HYUNDAI AUTOEVER CORP., Seoul (KR)

(72) Inventors: Ho Jin Jung, Hwaseong-si (KR); Seung Yeon Jeong, Hwaseong-si (KR); Young June Lee, Anyang-si (KR)

(73) Assignees: HYUNDAI MOTOR COMPANY, Seoul (KR); KIA CORPORATION, Seoul (KR); HYUNDAI AUTOEVER CORP., Seoul (KR)

(21) Appl. No.: 19/008,427

(22) Filed: Jan. 2, 2025

(30) Foreign Application Priority Data
Jul. 19, 2024 (KR) 10-2024-0095758

(51) Int. Cl. H04L 9/08; B60R 25/24

(52) U.S. Cl. CPC H04L 9/0877; B60R 25/248; H04L 2209/84

(57) ABSTRACT

An apparatus and method for provisioning a security key for vehicle control are provided. The apparatus may include at least one processor, and a hardware security module (HSM) including at least one first memory storing at least one program executable by the at least one processor. The at least one processor may de-obfuscate an obfuscated security key set included in an HSM operating firmware when powered on and may store the de-obfuscated security key set in a second memory.

### CROSS-REFERENCE TO RELATED APPLICATION

This application claims priority to and the benefit of Korean Patent Application No. 10-2024-0095758, filed on Jul. 19, 2024, the entire contents of which are hereby incorporated herein by reference.

### BACKGROUND

### 1. Technical Field

The present disclosure relates to a vehicle control apparatus and a method for provisioning a security key. More particularly, the present disclosure relates to a vehicle control apparatus and method for provisioning a security key capable of safely performing key provisioning by de-obfuscating the security key, temporarily storing the de-obfuscated security key, and then deleting the security key when the use is completed.

### 2. Discussion of Related Art

Vehicle built-in systems use a hardware security module (HSM) to manage security keys of a vehicle. Various security keys used for security functions have to be injected at a stage prior to mass production. As one example, when a provisioning service provided by a semiconductor manufacturer is used, a provisioning process has to be performed in conjunction with a key management system (KMS) and at a mass production process stage. Accordingly, depending on the performance of the vehicle built-in system, a process time increases, a manufacturing process becomes complex, and the costs increase. As one of the existing methods used to solve the problems, there is a method in which an HSM provider pre-injects an unencrypted security key (pre-shared Key (PSK)) into the HSM firmware binary and distributes HSM firmware to developers.

When the HSM provider distributes the HSM firmware binary including the security key, since a key provisioning stage is omitted during a vehicle control process, cost and time may be saved. However, because the security key is embedded in the binary, a problem of security vulnerability arises. For example, during development stage of a controller for the vehicle built-in system, the developer can extract an address and a security key value of the corresponding security key through reverse analysis.

### SUMMARY

Embodiments of the present disclosure provide a vehicle control apparatus and method for security key provisioning capable of preventing security key hacking that may occur during the development and mass production of the vehicle control apparatus or a hardware security module (HSM) in advance.

Technical problems to be solved in the present disclosure are not limited to the above-mentioned technical problems. Other technical problems that are not mentioned herein should be more clearly understood by those of ordinary skill in the art to which the present disclosure pertains from the following description.

According to an aspect of the present disclosure, a vehicle control apparatus for provisioning a security key is provided. The vehicle control apparatus includes at least one processor and a hardware security module (HSM) including at least one first memory storing at least one program executed by the at least one processor. The processor de-obfuscates an obfuscated security key set included in an HSM operating firmware when powered on and stores the de-obfuscated security key set in a second memory.

The processor may delete the de-obfuscated security key set stored in the second memory when a power off command is received.

The second memory may be a volatile memory.

An HSM build server may generate at least one obfuscation key, obfuscate a security key set using the generated at least one obfuscation key, and inject the obfuscated security key set into the HSM operating firmware.

The processor may be configured to generate at least one obfuscation key when powered on and de-obfuscate the security key set using the generated at least one obfuscation key.

The processor may generate an obfuscation key identical to an obfuscation key used when generating the obfuscated security key set in an HSM build server.

According to another aspect of the present disclosure, another vehicle control apparatus for provisioning a security key is provided. The vehicle control apparatus includes at least one processor and a hardware security module (HSM) including at least one first memory storing at least one program executed by the at least one processor. The processor de-obfuscates a security key related to a crypto service in an obfuscated security key set included in an HSM operating firmware when the crypto service provided by the HSM is requested after booting and stores the de-obfuscated security key in a second memory.

The processor may delete the de-obfuscated security key stored in the second memory when the crypto service is terminated.

An HSM build server may generate at least one obfuscation key, obfuscate each security key included in a security key set using the generated at least one obfuscation key and inject the security key set including the obfuscated security keys into the HSM operating firmware.

The processor may be configured to generate at least one obfuscation key when the crypto service is requested and de-obfuscate a security key related to the crypto service in the security key set using the generated at least one obfuscation key.

The processor may generate an obfuscation key identical to an obfuscation key used when generating the obfuscated security key in an HSM build server.

According to still another aspect of the present disclosure, a method of provisioning a security key that is performed by at least one processor is provided. The method includes de-obfuscating an obfuscated security key set included in a hardware security module (HSM) operating firmware of an HSM when powered on and storing the de-obfuscated security key set in a second memory.

The method may further include deleting the de-obfuscated security key set stored in the second memory when a power off command is received.

The second memory may be a volatile memory.

An HSM build server may generate at least one obfuscation key, obfuscate a security key set using the generated at least one obfuscation key, and inject the obfuscated security key set into the HSM operating firmware.

The de-obfuscating may include generating at least one obfuscation key when powered on and de-obfuscating the security key set using the generated at least one obfuscation key.

In the generating of the obfuscation key, an obfuscation key identical to an obfuscation key used when generating the obfuscated security key set in an HSM build server may be generated.

According to yet another aspect of the present disclosure, another method of provisioning a security key that is performed by at least one processor is provided. The method includes de-obfuscating a security key related to a crypto service in an obfuscated security key set included in a hardware security module (HSM) operating firmware when the crypto service provided by an HSM is requested after booting the HSM, and storing the de-obfuscated security key in a second memory.

The method may further include deleting the de-obfuscated security key stored in the second memory when the crypto service is terminated.

An HSM build server may generate at least one obfuscation key, obfuscate each security key included in a security key set using the generated at least one obfuscation key and inject the security key set including the obfuscated security keys into the HSM operating firmware.

The de-obfuscating may include generating at least one obfuscation key when the crypto service is requested and de-obfuscating a security key related to the crypto service in the security key set using the generated at least one obfuscation key.

In the generating of the obfuscation key, an obfuscation key identical to an obfuscation key used when generating the obfuscated security key in an HSM build server may be generated.

The features briefly summarized above with respect to the present disclosure are only illustrative aspects of the detailed description of the present disclosure below, and do not limit the scope of the present disclosure.

### BRIEF DESCRIPTION OF THE DRAWINGS

The above and other objects, features, and advantages of the present disclosure should be more apparent to those of ordinary skill in the art from the following description taken in conjunction with the accompanying drawings, in which:

FIG. 1 is a view illustrating a vehicle transmitting and receiving data by communicating with another device according to an embodiment of the present disclosure;

FIG. 2 is a diagram showing modules constituting a vehicle, according to an embodiment of the present disclosure;

FIG. 3 is a diagram showing a security key provisioning system for vehicle control, according to an embodiment of the present disclosure;

FIG. 4 is a block diagram showing a hardware security module (HSM) build server for security key provisioning shown in FIG. 3, according to an embodiment of the present disclosure;

FIG. 5 is a block diagram showing a vehicle control apparatus for security key provisioning shown in FIG. 3, according to an embodiment of the present disclosure;

FIG. 6 is a diagram for describing a configuration of a second processor of the vehicle control apparatus shown in FIG. 5, according to an embodiment of the present disclosure;

FIG. 7 is a diagram showing a security key provisioning system for vehicle control, according to another embodiment of the present disclosure;

FIG. 8 is a block diagram showing a second HSM build server shown in FIG. 7, according to an embodiment of the present disclosure;

FIG. 9 is a block diagram showing a second vehicle control apparatus for security key provisioning shown in FIG. 7, according to an embodiment of the present disclosure;

FIG. 10 is a diagram for describing a configuration of a fourth processor of a second HSM, according to another embodiment of the present disclosure;

FIG. 11 is a flowchart for describing a method of generating a security key for security key provisioning, according to an embodiment of the present disclosure;

FIG. 12 is a flowchart for describing a method of provisioning a security key for vehicle control by a vehicle control apparatus, according to an embodiment of the present disclosure;

FIG. 13 is a flowchart for describing a method of generating a security key for security key provisioning, according to another embodiment of the present disclosure; and

FIG. 14 is a flowchart for describing a method of provisioning a security key for vehicle control by a second vehicle control apparatus, according to another embodiment of the present disclosure.

### DETAILED DESCRIPTION

Hereinafter, embodiments of the present disclosure are described in detail with reference to the accompanying drawings to enable those having ordinary skill in the art to which the present disclosure pertains to implement the embodiments of the present disclosure. However, the present disclosure may be implemented in many different forms and is not limited to the embodiments described herein.

Furthermore, in describing embodiments of the present disclosure, when it was determined that a detailed description of a known configuration or function may obscure the subject matter of the present disclosure, the detailed description thereof has been omitted. In addition, in the drawings, parts that are not related to the description of the present disclosure are omitted, and similar parts are given similar reference numerals.

In the present disclosure, when a component is referred to as being “connected to,” “coupled to,” or “linked to” another component, it may include an indirect connection where another element may be present therebetween as well as a direct connection. In addition, when a component “includes” or “has” another component, unless described to the contrary, the term “includes” or “has” does not indicate that the component excludes another component but instead indicates that the component may further include another component.

When a component, device, element, or the like of the present disclosure is described as having a purpose or performing an operation, function, or the like, the component, device, or element should be considered herein as being “configured to” meet that purpose or perform that operation or function.

In the present disclosure, terms such as first, second, etc., are used only for the purpose of distinguishing one component from other components. These terms do not limit the order or importance between components unless specifically mentioned. Therefore, within the scope of the present disclosure, a first component in one embodiment may be referred to as a second component in another embodiment, and similarly, a second component in one embodiment may be referred to as a first component in another embodiment.

In the present disclosure, distinct components are intended to clearly describe respective features, and do not necessarily mean that the components are separated. For example, a plurality of components may be integrated to form one hardware or software unit, or one component may be distributed to form a plurality of hardware or software units. Accordingly, even when not separately mentioned, such integrated or distributed embodiments are also included in the scope of the present disclosure.

In the present disclosure, components described in various embodiments do not necessarily mean essential components, and some may be optional components. Accordingly, embodiments constituted by a subset of components described in one embodiment are also included in the scope of the present disclosure. In addition, embodiments that include other components in addition to those described in various embodiments are also included in the scope of the present disclosure.

In the present disclosure, each of phrases such as “A or B,” “at least one of A and B,” “at least one of A or B,” “A, B or C,” “at least one of A, B and C,” and “at least one of A, B, C, or a combination thereof” may include any one of the items listed in the phrase, or all possible combinations of the items.

Advantages and features of the present disclosure, and methods for achieving the advantages and features are provided with reference to embodiments described below in detail together with the accompanying drawings. However, the present disclosure is not limited to the embodiments presented below. Rather, the present disclosure may be implemented in a variety of different forms. The described embodiments are only provided to make the present disclosure complete, and to completely inform those having ordinary skill in the art to which the present disclosure pertains of the scope of the present disclosure.

In addition, in the present specification, terms such as “module,” “unit,” “device,” “server,” etc. may be intended to refer to the functional and structural combination of hardware or software driven by or for driving the hardware. For example, the hardware may be a data processing device including a CPU or other processor. In addition, software driven by hardware may refer to a running process, object, executable, thread of execution, program, etc.

In the present disclosure, a “system” may include one or more computing devices and may be provided in a local or cloud form, but is not limited thereto.

In the present disclosure, “security key provisioning” may refer to a process or operation of processing or providing a security key in a usable state to execute a process or security service provided by a hardware security module (HSM).

In the present disclosure, the “crypto service” may be ported to an application that interfaces with a vehicle control apparatus or HSM (e.g., may be installed in a vehicle 100 or a user terminal (e.g., a smartphone) capable of communicating with the vehicle 100) in advance using an HSM driver and may be set so that the application requests the crypto service from the HSM of the vehicle control apparatus, when the application requires a security algorithm. Porting may mean porting software from one platform to another, and may include a process of changing existing software to operate in a new environment. A platform generally refers to an operating system (OS) or hardware architecture. Modifying a source code or compiling or rewriting an existing code to fit a new environment is a common porting method. In this way, the software may run on different operating systems and hardware.

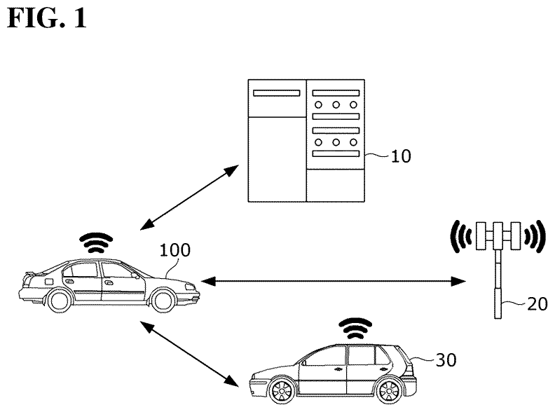

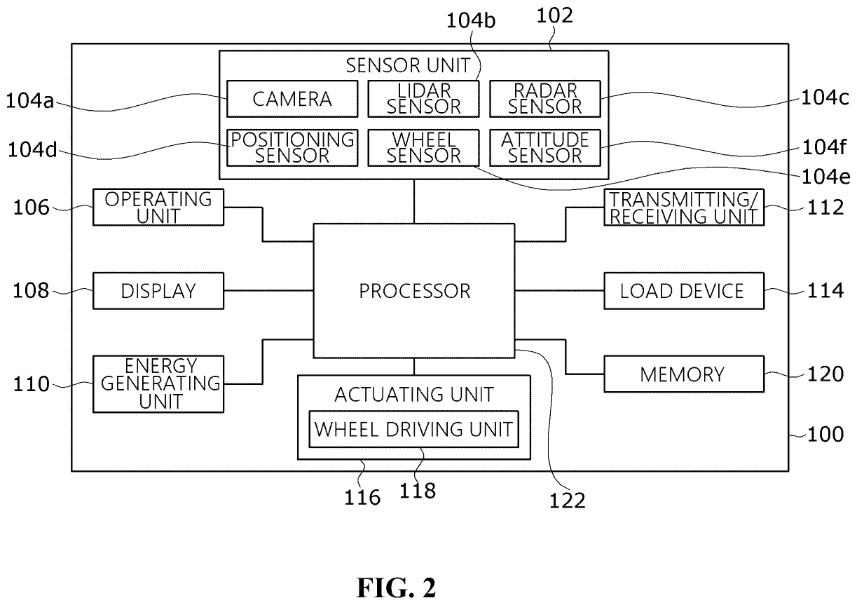

Hereinafter, a vehicle 100 in which a vehicle control apparatus according to an embodiment of the present disclosure may be used is described with reference to FIGS. 1 and 2.

FIG. 1 is a view illustrating that the vehicle 100 communicates with another device to transmit and receive data.

Referring to FIG. 1, the vehicle 100 may be driven based on electrical energy or fossil energy. In the case of electrical energy, the vehicle 100 may be, for example, a pure battery-based vehicle powered only by a high-voltage battery, or may use a gas-based fuel cell as an energy source. In addition, the fuel cell may use various types of gas capable of generating electrical energy, and the vehicle 100 may be filled with the gas in a liquefied state, for example. The gas may be hydrogen as one example. However, the gas is not limited thereto, and various gases are applicable. In the case of fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotational force of wheels to a wheel driving unit 118. As another example, the vehicle 100 may drive the actuating unit 116 by selectively utilizing energy from a fossil energy-based internal combustion engine and an electric battery, and may be a hybrid type vehicle.

The vehicle 100 may be a ground vehicle that travels on the ground. For example, the vehicle 100 may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle refer to a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but unless otherwise inconsistent with the present disclosure, the present embodiment may also be applied to air mobility devices such as AAMs, aircraft, or the like, and water mobility devices such as ships, submarines, or the like.

The vehicle 100 may be controlled and driven by autonomous driving. The autonomous driving may be implemented as semi-autonomous driving or fully autonomous driving. Fully autonomous driving may be provided as autonomous movement in which a processor 122 of the vehicle 100 takes full control without user intervention, even when a driving situation is uncertain. Semi-autonomous driving may be provided as autonomous movement that requires driver intervention depending on specific driving situations. Semi-autonomous driving may be implemented so that the processor 122 transfers control to a user while deactivating autonomous driving when the aforementioned situation occurs, allowing the user to perform manual driving. According to the levels of autonomous driving defined by the Society of Automotive Engineers (SAE), semi-autonomous driving may correspond to autonomous driving levels 1 to 4, and fully autonomous driving may correspond to level 5.

The vehicle 100 may communicate with other devices 10 and 20 or another vehicle 30. Other devices may include, for example, a server 10 that supports various controls, state management, and driving of the vehicle 100, an intelligent transportation system (ITS) device 20 for receiving information from an ITS, various types of user devices, or the like. The server 10 may be, for example, an external device operated by a vehicle manufacturer or provided to service autonomous driving and may receive connected data of the vehicle 100 or transmit data necessary for autonomous driving. The server 10 may transmit various information and software modules used to control the vehicle 100 to the vehicle 100 in response to the request and data transmitted from the vehicle 100 and the user device to support autonomous driving and various services of the vehicle 100.

The ITS device 20 may be, for example, a roadside unit (RSU). The ITS device 20 may assist the user in driving his or her own vehicle or support autonomous driving of the vehicle 100 by exchanging vehicle recognition data, driving control and state data, environmental data around the vehicle, map data, or the like, through V2I with the vehicle 100. The vehicle 100 may support manual driving or autonomous driving by exchanging the data listed above through V2V with the other vehicle 30.

The vehicle 100 may communicate with other vehicles or other devices based on cellular communication, wireless access in vehicular environment (WAVE) communication, dedicated short range communication (DSRC), or short-range communication, or other communication methods.

For example, the vehicle 100 may use a cellular communication network such as LTE or 5G, WiFi communication network, WAVE communication network, or the like, for communication with the server 10, the ITS device 20, and the other vehicle 30. As another example, DSRC or the like used in the vehicle 100 may be used for communication between vehicles. The communication method between the vehicle 100, the server 10, the ITS device 20, the other vehicle 30, and the user device is not limited to the above-described embodiment.

FIG. 2 is a diagram showing modules constituting a vehicle according to one embodiment of the present disclosure.

A vehicle 100 may include a sensor unit 102, an operating unit 106, a display 108, a load device 114, a transmitting/receiving unit 112, an energy generating unit 110, an actuating unit 116, a memory 120, and a processor 122.

The sensor unit 102 may be provided with various types of detectors to detect various states and situations occurring in an external environment, an internal system, a user operation, and a boarding space of the vehicle 100.

For example, the sensor unit 102 may be provided with an externally oriented camera 104a, a lidar sensor 104b, a radar sensor 104c, and the like, to recognize dynamic and static objects existing outside the vehicle 100. The camera 104a may recognize an external object as an image while the vehicle 100 is in use, generate image data, and transmit the image data to the processor 122. The lidar sensor 104b may generate point cloud data as recognized data of the external object and transmit the point cloud data to the processor 122 to generate 3D spatial information that identifies at least a shape of the external object. In order to ascertain the presence of an external object and its relative distance, speed, direction, or the like, the radar sensor 104c may emit radio waves of a specific frequency around the vehicle 100 and generate radar data through radio waves reflected from the external object. In FIG. 2, the sensor unit is illustrated as having the lidar sensor 104b, but in other examples, the lidar sensor 104b may not be mounted.

The sensor unit 102 may be provided with a positioning sensor 104d, a wheel sensor 104e, an attitude sensor 104f, or the like, to confirm its own location, speed, driving attitude, and the like. The attitude sensor 104f may include a gyro sensor, an angular velocity sensor, an acceleration sensor, or the like.

The operating unit 106 may be configured as a module controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use the autonomous driving function. In order to receive various requests related to autonomous driving, the operating unit 106 may be configured, for example, as a hard-type interface provided at a predetermined position inside the vehicle 100, or as a soft-type interface that capable of being touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 122. In addition, the display 108 may be configured as a touch screen capable of detecting driver input to receive a driver's request to instruct the processor 122.

The load device 114 is mounted on the vehicle 100 and may be a type of non-driving electric device excluding a driving power system such as the wheel driving unit 118 or the like. The load device 114 is an auxiliary device that receives electric power from the energy generating unit 110, and may be, for example, an air conditioning system, a lighting system, a seat system, various devices installed in the vehicle 100, or the like. In an embodiment, a cooling/heating system that cools or heats at least one of the battery, the fuel cell, the internal combustion engine, the air conditioning system, and a specific part of the vehicle 100 may be further included.

The transmitting/receiving unit 112 may support mutual communication with the server 10, the ITS device 20, surrounding vehicles 20, and the like. The transmitting/receiving unit 112 may include a module that processes, for example, cellular communication, WAVE, DSRC communication, and the like. In an embodiment, the transmitting/receiving unit 112 may transmit data generated or stored while driving to the server 10 and receive data and software modules transmitted from the server 10. The transmitting/receiving unit 112 may support communication with an electronic device carried by an occupant inside the vehicle 100. In the present disclosure, the vehicle 100 may transmit and receive data utilized in a method according to the present disclosure to the outside through the transmitting/receiving unit 112.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112. However, the non-driving power system is not limited thereto, and may include various components that implement sensing, interface, communication, and convenience functions, excluding components directly involved in driving operations. When the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as the internal combustion engine. In addition, when the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 122 by a manual operation of the user or autonomous driving, the actuating unit 116 may be provided with the wheel driving unit 118 and mechanical components and electronic modules for implementing the driving operations in the wheel driving unit 118. When the vehicle 100 is operated based on electric energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

The memory 120 may store at least one program (e.g., operating system, software, firmware, middleware, or application, etc.), various data, and at least one command for controlling the vehicle 100, thereby making it possible to load a program, read and write data, or perform an operation corresponding to a command at the request of the processor 122. The memory 120 may include a volatile memory and a non-volatile memory.

The processor 122 may perform overall control of the vehicle 100 according to input commands. Commands may be input to the processor 122 through the memory 120 or the transmitting/receiving unit 112. As one example, the processor 122 may control operations of other components (hardware or software) connected to the vehicle 100 and perform data processing and calculations by executing programs or instructions stored in the memory 120. The processor 122 may include, for example, at least one of at least one central processing unit, at least one microprocessor, and at least one digital signal processor (DSP). In addition, the processor 122 may load commands or data received from other components (e.g., the sensor unit 102 or the transmitting/receiving unit 112) into the volatile memory, process the commands or data stored in the volatile memory, and store processing results in the non-volatile memory.

According to one embodiment, the vehicle 100 may be provided with at least one vehicle control apparatus. At least one vehicle control apparatus may be provided in the form of an embedded system inside the vehicle 100. When a plurality of vehicle control apparatuses are provided, the vehicle control apparatus may be implemented as independent devices for each function of the vehicle control apparatus, or may be connected to communicate with each other. In addition, at least one vehicle control apparatus may be implemented integrally with vehicle internal control units (e.g., the processor 122) or may be implemented as a separate and independent chip. As one example, at least one controlling apparatus may be implemented in various forms such as an electronic control unit (ECU), micro controller unit (MCU), central processing unit (CPU), microprocessor, or the like.

A function capable of being controlled by at least one vehicle control apparatus may be one of various vehicle control functions including engine control, transmission control, electronic stability control, airbag control, tire pressure monitoring system, motor control, seat control, door control, and the like.

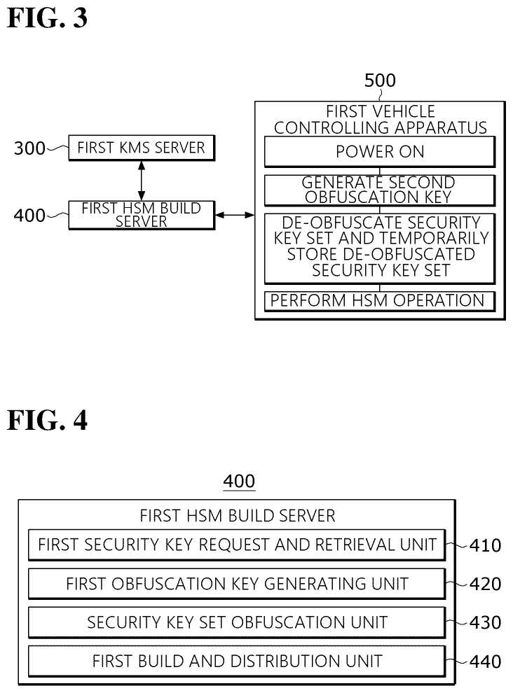

FIG. 3 is a diagram showing a security key provisioning system for vehicle control according to one embodiment of the present disclosure.

Referring to FIG. 3, the security key provisioning system for vehicle control may include a first key management system (KMS) server 300, a first HSM build server 400, and a first vehicle control apparatus 500. The first KMS server 300 and the first HSM build server 400 may be implemented to be integrated into one computing device, or may be implemented as a separate and independent computing device. Accordingly, the first KMS server 300 and the first HSM build server 400 may each include at least one memory and at least one processor (not shown in FIG. 3). In addition, although FIG. 3 shows the system including one first vehicle control apparatus 500, the system including a plurality of vehicle control apparatuses is also possible.

The first KMS server 300 may generate a plurality of security keys to be injected into the first vehicle control apparatus 500 based on a request from the first HSM build server 400. The first KMS server 300 may map identification information about the first HSM build server 400 that has requested the generation of a plurality of security keys and the plurality of generated security keys and may store the identification information and security keys as a security key set.

The first HSM build server 400 may request the first KMS server 300 to generate a plurality of security keys and may obfuscate the security key set including the plurality of generated security keys.

When the first vehicle control apparatus 500 is powered on, the first vehicle control apparatus 500 may de-obfuscate the obfuscated security key set included in an HSM operating firmware and may temporarily store the de-obfuscated security key set in the volatile memory. When powered off, the first vehicle control apparatus 500 may delete the de-obfuscated security key set temporarily stored in the volatile memory.

FIG. 4 is a block diagram showing the first HSM build server 400 for security key provisioning according to one embodiment of the present disclosure shown in FIG. 3.

Referring to FIG. 4, the first HSM build server 400 may include a first security key request and retrieval unit 410, a first obfuscation key generating unit 420, a security key set obfuscation unit 430, and a first build and distribution unit 440.

The first security key request and retrieval unit 410 may request the first KMS server 300 to generate a plurality of security keys and may retrieve the security key set generated and stored in the first KMS server 300. The first HSM build server 400 may retrieve the security key set using the identification information (e.g., an ID of the first HSM build server 400) used when requesting security key generation.

The first obfuscation key generating unit 420 may generate a first obfuscation key for obfuscating the retrieved security key set. The first obfuscation key generating unit 420 may generate the first obfuscation key defined as a hash value using obfuscation information. The obfuscation information may include at least one of a unique ID within a first HSM 520, information for identifying the first HSM 520 (e.g., a serial number), a unique ID of the first vehicle control apparatus 500 to be provided with the first HSM 520, or identification information (e.g., a unique ID of the first HSM build server 400) used to request the first KMS server 300 to generate the security keys. In order to ensure security, the first obfuscation key generating unit 420 may generate the first obfuscation key using white box cryptography (WBC) or using an encryption algorithm applied differently for each first HSM 520 (e.g., an encryption algorithm that is undisclosed or used by a developer itself).

The security key set obfuscation unit 430 may generate an obfuscated security key set by obfuscating the security key set retrieved in the first KMS server 300 using the generated first obfuscation key. In other words, the security key set obfuscation unit 430 may data-encrypt the security key set using the first obfuscation key. The security key set obfuscation unit 430 may individually obfuscate a plurality of security keys included in the security key set and may then generate an obfuscated security key set by collecting the plurality of obfuscated security keys. Alternatively, the security key set obfuscation unit 430 may obfuscate the security key set itself, that includes a plurality of security keys. The first build and distribution unit 440 may inject the obfuscated security key set into the HSM operating firmware to build and then distribute the HSM operating firmware (or HSM operating stack).

As one example, the first build and distribution unit 440 may build the HSM operating firmware by injecting the obfuscated security key set, that is raw data, into a code area or data area of the HSM operating firmware. In this case, a form of the completed build may be a binary form.

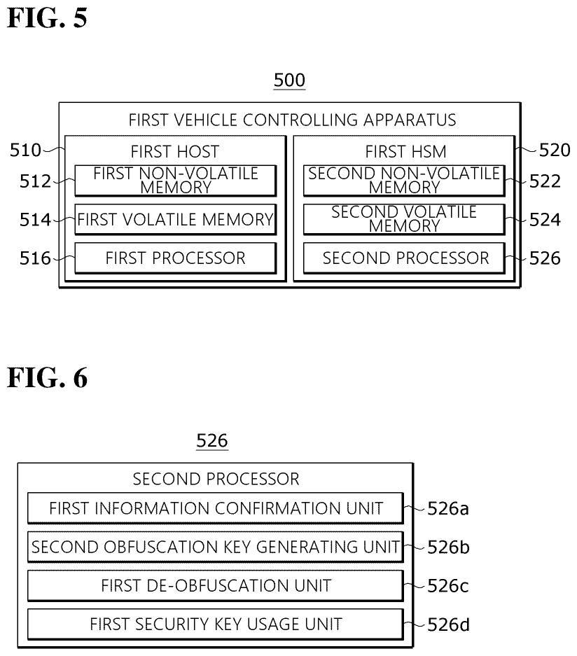

FIG. 5 is a block diagram showing the first vehicle control apparatus 500 for security key provisioning according to one embodiment of the present disclosure shown in FIG. 3.

Referring to FIG. 5, the first vehicle control apparatus 500 may include a first host 510 for driving the first vehicle control apparatus 500 and the first HSM 520 for security of the first vehicle control apparatus 500.

The first host 510 may include a first non-volatile memory 512, a first volatile memory 514, and a first processor 516.

The first non-volatile memory 512 may store a plurality of programs including a boot loader for booting and driving the first vehicle control apparatus 500, at least one application, and an HSM driver.

The first volatile memory 514 may temporarily store data generated while the first host 510 operates.

The first processor 516 may control or process the overall operation of the first host 510. As one example, the first processor 516 may boot the first vehicle control apparatus 500 and control the operation of the first vehicle control apparatus 500 to perform functions assigned to the first vehicle control apparatus 500, or may process a plurality of items of data or a plurality of operations, such as performing processing to download and transmit the HSM operating firmware to the first HSM 520 according to a command of a developer of the first vehicle control apparatus 500.

In addition, the first processor 516 may transmit a power-on signal and a power-off signal to the first HSM 520 through an HSM application programming interface (API).

The power-on signal is a signal indicating that the first vehicle control apparatus 500 is powered on, and being powered on means that the first vehicle control apparatus 500 performs a booting operation. The first HSM 520 may generate a second obfuscation key during booting and de-obfuscate the security key set.

The power-off signal is a signal indicating that a power off command of the first vehicle control apparatus 500 has been received. When the power-off signal is received, the first HSM 520 may delete the temporarily stored second obfuscation key and the de-obfuscated security key set from the first volatile memory 514 and then terminate the operation of the first HSM 520.

The first HSM 520 may include a second non-volatile memory 522, a second volatile memory 524, and a second processor 526.

The second non-volatile memory 522 may include at least one of a volatile memory and a non-volatile memory. The second non-volatile memory 522 may store a plurality of programs that control the operation of the first HSM 520. The plurality of programs stored in the second non-volatile memory 522 may include the HSM operating firmware for operating the first HSM 520. The HSM operating firmware may include at least one command for de-obfuscating the security key set by generating the second obfuscation key, temporarily storing the de-obfuscated security key set in the second volatile memory 524, and deleting the de-obfuscated security key set temporarily stored in the second volatile memory 524 when powered off.

In addition, the second non-volatile memory 522 may store obfuscation information required to generate the second obfuscation key. The obfuscation information is information used when the first obfuscation key is generated in the first HSM build server 400. The obfuscation information may be the same as the obfuscation information used in the first HSM build server 400.

The second volatile memory 524 may temporarily store the second obfuscation key and the de-obfuscated security key set. The second volatile memory 524 may be a random-access memory (RAM), for example.

The second processor 526 may control the overall operation of the first HSM 520. As one example, the second processor 526 may store the HSM operating firmware distributed by the first HSM build server 400 in the second non-volatile memory 522 and may execute the HSM operating firmware by a command of the developer of the first vehicle control apparatus 500. When the first vehicle control apparatus 500 is powered on, the second processor 526 may de-obfuscate the obfuscated security key set included in the HSM operating firmware and may temporarily store the de-obfuscated security key set in the second volatile memory 524. In addition, when a power-off signal is received, the second processor 526 may delete the de-obfuscated security key set temporarily stored in the second volatile memory 524.

FIG. 6 is a diagram for describing a configuration of the second processor 526 of the first vehicle control apparatus 500 according to one embodiment of the present disclosure.

Referring to FIG. 6, the second processor 526 may include a first information confirmation unit 526a, a second obfuscation key generating unit 526b, a first de-obfuscation unit 526c, and a first security key usage unit 526d. Each component of the second processor 526 may be a functionally distinct element to describe the operation of the second processor 526, and may be implemented in a physically independent form or in an integrated form. In addition, at least one of the first information confirmation unit 526a, the second obfuscation key generating unit 526b, the first de-obfuscation unit 526c, and/or the first security key usage unit 526d may be implemented as a command included in the HSM operating firmware.

The first information confirmation unit 526a, the second obfuscation key generating unit 526b, and the first de-obfuscation unit 526c may operate while the first vehicle control apparatus 500 is booting.

When a power-on signal is input from the first host 510 to the HSM API, the first information confirmation unit 526a may confirm the obfuscation information required to generate the second obfuscation key in the second non-volatile memory 522.

The second obfuscation key generating unit 526b may generate the second obfuscation key using the obfuscation information confirmed by the first information confirmation unit 526a. Accordingly, the second obfuscation key generating unit 526b may generate the second obfuscation key having the same configuration as the first obfuscation key generated in the first HSM build server 400.

The first de-obfuscation unit 526c may de-obfuscate the security key set using the second obfuscation key generated by the second obfuscation key generating unit 526b. In other words, the first de-obfuscation unit 526c may decrypt the obfuscated security key set injected into the HSM operating firmware using the second obfuscation key. Accordingly, the first de-obfuscation unit 526c may obtain a security key set including the same security keys as the security keys generated in the first KMS server 300. In addition, the first de-obfuscation unit 526c may store the de-obfuscated security key set and the second obfuscation key in the second volatile memory 524.

When booting is completed, the first security key usage unit 526d may perform the operation of the first HSM 520 (e.g., data encryption/decryption, certificate verification, or the like) in the development process or mass production process using the de-obfuscated security key set.

In addition, when a power-off signal is input from the first host 510, the first security key usage unit 526d may perform processing to delete the second obfuscation key and the de-obfuscated security key set temporarily stored in the second volatile memory 524 and may then terminate the operation of the first HSM 520.

According to one embodiment of the present disclosure described with reference to FIGS. 3-6, the first vehicle control apparatus 500 may operate equally in both the process of developing the first vehicle control apparatus 500 and the processing of mass-producing the first vehicle control apparatus 500. Therefore, the first vehicle control apparatus 500 may always perform key provisioning that de-obfuscates the security key when powered on.

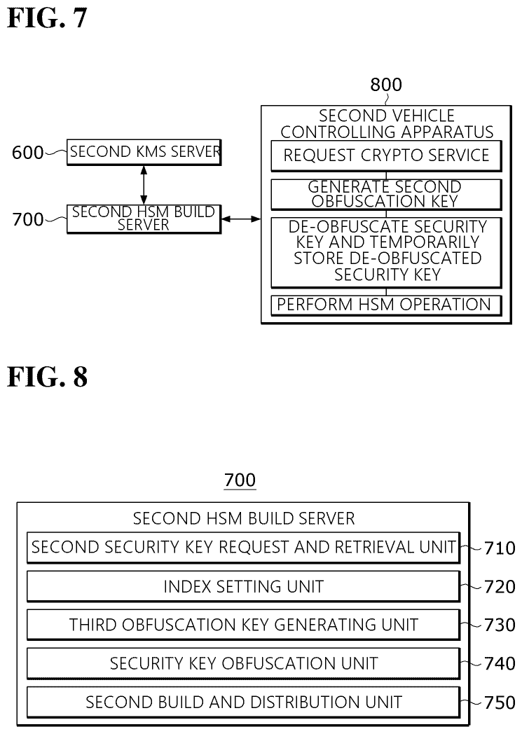

FIG. 7 is a diagram showing a security key provisioning system for vehicle control according to another embodiment of the present disclosure.

Referring to FIG. 7, the security key provisioning system for vehicle control may include a second KMS server 600, a second HSM build server 700, and a second vehicle control apparatus 800. Since the operation and configuration of the second KMS server 600 and the second HSM build server 700 shown in FIG. 7 are almost the same as those of the first KMS server 300 and the first HSM build server 400 described with reference to FIGS. 3 and 4), the detailed description thereof is omitted below.

The second KMS server 600 may generate a plurality of security keys to be injected into the second vehicle control apparatus 800 based on a request of the second HSM build server 700 and may map and store identification information about the second HSM build server 700 and the plurality of generated security keys.

The second HSM build server 700 may request the second KMS server 600 to generate the plurality of security keys and may obfuscate the plurality of generated security keys. The second HSM build server 700 may obfuscate each of the plurality of security keys and generate a security key set by collecting the plurality of obfuscated security keys.

When a crypto service request is received, the second vehicle control apparatus 800 may de-obfuscate a security key corresponding to the crypto service in the obfuscated security key set included in an HSM operating firmware and may temporarily store the de-obfuscated security key in a volatile memory. When the requested crypto service is terminated, the second vehicle control apparatus 800 may delete the security key temporarily stored in the volatile memory.

FIG. 8 is a block diagram showing the second HSM build server 700 shown in FIG. 7, according to an embodiment.

Referring to FIG. 8, the second HSM build server 700 may include a second security key request and retrieval unit 710, an index setting unit 720, a third obfuscation key generating unit 730, a security key obfuscation unit 740, and a second build and distribution unit 750. Since the second HSM build server 700, the second security key request and retrieval unit 710, the third obfuscation key generating unit 730, the security key obfuscation unit 740, and the second build and distribution unit 750, which are shown in FIG. 8, are almost the same as the first HSM build server 400, the first security key request and retrieval unit 410, the first obfuscation key generating unit 420, and the security key set obfuscation unit 430, and the first build and distribution unit 440, which have been described with reference to FIG. 4, the detailed description thereof is omitted below.

The second security key request and retrieval unit 710 may request the second KMS server 600 to generate a plurality of security keys and may retrieve the plurality of security keys stored in the second KMS server 600 using the identification information used when requesting the generation of the security keys.

The index setting unit 720 may set an index for each of the plurality of security keys retrieved according to a user command of the second HSM build server 700 and may map the identification information about a crypto service for which each security key is to be used with an index of a related security key. Accordingly, the same index may be set for one security key and the crypto service for which the security key is to be used. In addition, the index setting unit 720 may map a plurality of security keys to one crypto service, and in this case, for the crypto service, may set an index set for a plurality of security keys.

To this end, a user of the second HSM build server 700 may receive identification information for each of the crypto services provided by the second vehicle control apparatus 800 in advance and store the received information in the second HSM build server 700. In addition, the index setting unit 720 may generate an index list file in which an index is set for each crypto service and transmit the index list file to the second build and distribution unit 750.

The third obfuscation key generating unit 730 may generate a third obfuscation key to obfuscate the plurality of retrieved security keys.

The security key obfuscation unit 740 may obfuscate each of the security keys retrieved in the second KMS server 600 using the generated third obfuscation key and may generate an obfuscated security key set by collecting a plurality of obfuscated security keys. The second build and distribution unit 750 may inject the obfuscated security key set into the HSM operating firmware to build and may then distribute the HSM operating firmware (or HSM operating stack). In addition, the second build and distribution unit 750 may encrypt the file storing the index list and may distribute the encrypted index list file by injecting the encrypted index file into the HSM operating firmware.

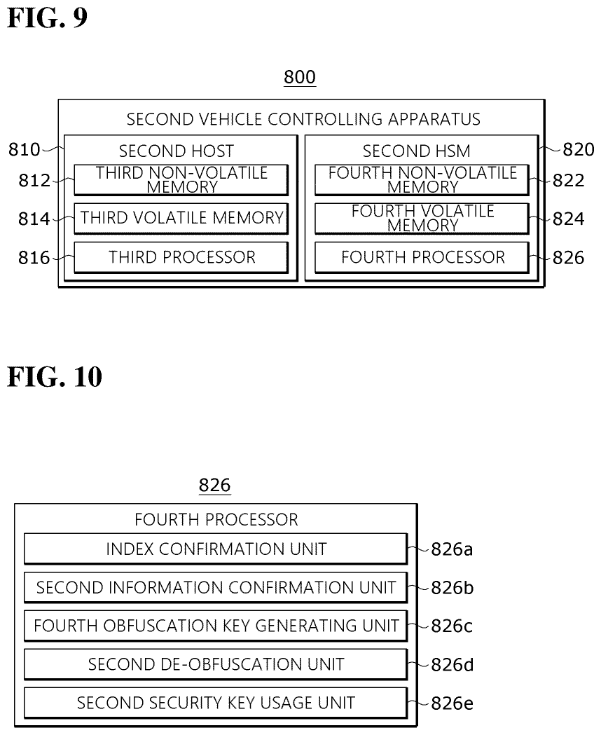

FIG. 9 is a block diagram showing the second vehicle control apparatus 800 for security key provisioning shown in FIG. 7, according to an embodiment.

Referring to FIG. 9, the second vehicle control apparatus 800 may include a second host 810 for driving the second vehicle control apparatus 800 and the second HSM 820 for security of the second vehicle control apparatus 800. Among the operations or configurations of the second host 810 and the second HSM 820 shown in FIG. 9, detailed descriptions of parts that are the same as those of the first host 510 and the first HSM 520 described with reference to FIG. 5 are omitted below.

The second host 810 may include a third non-volatile memory 812, a third volatile memory 814, and a third processor 816.

The third processor 816 may transmit a crypto service request command to the second HSM 820 through the HSM API. The crypto service request command is a command received from an electronic device on which the application of the second vehicle control apparatus 800 is installed or an electronic device capable of communicating with the second vehicle control apparatus 800, and may be a command requesting to perform the crypto service provided by the second HSM 820. As one example, the crypto service may include various security algorithm services using security keys such as AES128, AES-CMAC, and RSA2048.

The second HSM 820 may include a fourth non-volatile memory 822, a fourth volatile memory 824, and a fourth processor 826.

The fourth non-volatile memory 822 may store the HSM operating firmware, the index list file, and the decryption program for operating the second HSM 820. The HSM operating firmware may include at least one command for de-obfuscating at least one security key related to the crypto service by generating a fourth obfuscation key, temporarily storing the de-obfuscated security key in the fourth volatile memory 824, and deleting the de-obfuscated security key and the fourth obfuscation key temporarily stored in the fourth volatile memory 824 when the requested crypto service is terminated. In addition, the fourth non-volatile memory 822 may store obfuscation information required to generate the fourth obfuscation key. The obfuscation information may be the same as the obfuscation information used in the second HSM build server 700.

The index list file may be decrypted by a decryption program and the decrypted index list file may be stored in the fourth non-volatile memory 822.

The fourth volatile memory 824 may temporarily store the fourth obfuscation key and the de-obfuscated security key. An example of the fourth volatile memory 824 may be a RAM.

The fourth processor 826 may control the overall operation of the second HSM 820. As one example, the fourth processor 826 may store and execute the HSM operating firmware into which the security key set is injected in the fourth non-volatile memory 822, may decrypt the index list file, and may then store the decrypted index list file in the fourth non-volatile memory 822. When a crypto service request command is input through the HSM API from the second host 810, the fourth processor 826 may de-obfuscate the security key related to the requested crypto service, may temporarily store the de-obfuscated security key in the fourth volatile memory 824, and may delete the de-obfuscated security key and the fourth obfuscation key temporarily stored in the fourth volatile memory 824 when the crypto service is terminated.

FIG. 10 is a diagram for describing a configuration of the fourth processor 826 of the second HSM 820 according to another embodiment of the present disclosure.

Referring to FIG. 10, the fourth processor 826 may include an index confirmation unit 826a, a second information confirmation unit 826b, a fourth obfuscation key generating unit 826c, a second de-obfuscation unit 826d, and a second security key usage unit 826e. Each component of the fourth processor 826 may be a functionally distinct element to describe the operation of the fourth processor 826, and may be implemented in a physically independent form or in an integrated form. In addition, at least one of the second information confirmation unit 826b, the fourth obfuscation key generating unit 826c, the second de-obfuscation unit 826d, and the second security key usage unit 826e may be implemented as a command included in the HSM operating firmware.

The index confirmation unit 826a, the second information confirmation unit 826b, the fourth obfuscation key generating unit 826c, and the second de-obfuscation unit 826d may operate after the second vehicle control apparatus 800 has completed booting.

When the crypto service request command is input from the second host 810, the index confirmation unit 826a may confirm the index mapped to the requested crypto service in the index list file and may transmit the confirmed index to the second de-obfuscation unit 826d.

When the crypto service request command is input, the second information confirmation unit 826b may confirm the obfuscation information required to generate the fourth obfuscation key in the fourth non-volatile memory 822.

The fourth obfuscation key generating unit 826c may generate the fourth obfuscation key using the obfuscation information confirmed by the second information confirmation unit 826b. Accordingly, the fourth obfuscation key generating unit 826c may generate the fourth obfuscation key having the same configuration as the third obfuscation key generated in the second HSM build server 700.

The second de-obfuscation unit 826d may de-obfuscate the security key set using the fourth obfuscation key generated by the fourth obfuscation key generating unit 826c. The second de-obfuscation unit 826d may confirm a security key having an index set to be identical to the index confirmed in the index confirmation unit 826a in the HSM operating firmware and decrypt the confirmed security key using the fourth obfuscation key. The second security key usage unit 826e may perform the operation (e.g., data encryption/decryption, certificate verification, or the like) of the second HSM 820 using the de-obfuscated security key.

In addition, when the crypto service requested from the second host 810 is terminated, the second security key usage unit 826e may delete the fourth obfuscation key and the de-obfuscated security key temporarily stored in the fourth non-volatile memory 822.

According to the embodiment of the present disclosure described with reference to FIGS. 7-10, the second vehicle control apparatus 800 may operate equally in both the process of developing the second vehicle control apparatus 800 and the process of mass-producing the second vehicle control apparatus 800. Therefore, whenever a crypto service is requested, the second vehicle control apparatus 800 may always perform key provisioning that de-obfuscates the security key related to the crypto service. In this case, compared to an embodiment in which the entire security key set is de-obfuscated, the booting time of the second vehicle control apparatus 800 may be shortened and RAM resource usage may be reduced.

In addition, according to the embodiment of the present disclosure described with reference to FIGS. 7-10, the embodiment in which the second HSM build server 700 maps identification information about a crypto service to the index of a security key is disclosed. However, the operation of mapping the identification information about the crypto service may be performed after the developer of the second vehicle control apparatus 800 executes the HSM operating firmware.

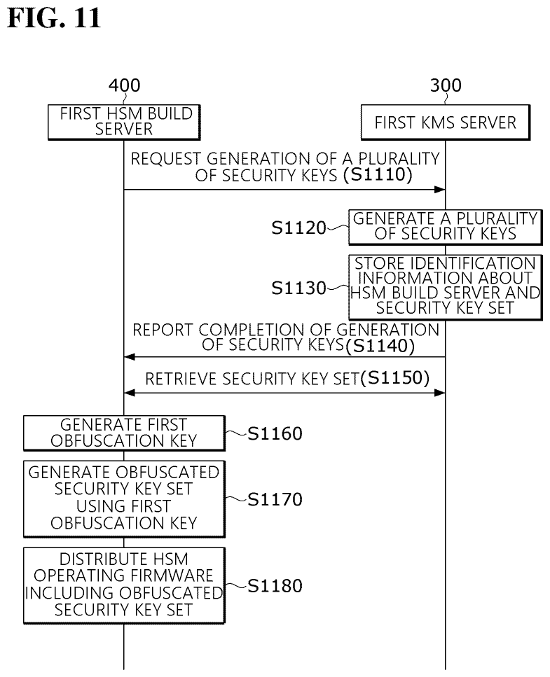

FIG. 11 is a flowchart for describing a method of generating a security key for security key provisioning according to one embodiment of the present disclosure.

Referring to FIG. 11, in an operation S1110, the first HSM build server 400 may request the first KMS server 300 to generate a plurality of security keys to be assigned to the first vehicle control apparatus 500. In the operation S1110, the first HSM build server 400 may request generation of security keys while transmitting identification information (e.g., a unique ID of the first HSM build server 400) about the first HSM build server 400 to the first KMS server 300.

In an operation S1120, the first KMS server 300 may generate a plurality of security keys to be injected into the first vehicle control apparatus 500.

In an operation S1130, the first KMS server 300 may map the identification information about the first HSM build server 400 that has requested generation of security keys and the plurality of generated security keys and store the information and security keys as a security key set.

In an operation S1140, the first KMS server 300 may report to the first HSM build server 400 that the generation of the security key set has been completed.

In an operation S1150, the first HSM build server 400 may retrieve (e.g., read) the security key set stored in the first KMS server 300 using the identification information used when requesting the generation of the security keys.

In an operation S1160, the first HSM build server 400 may generate a first obfuscation key for obfuscating the retrieved security key set using the obfuscation information.

In an operation S1170, the first HSM build server 400 may generate an obfuscated security key set by obfuscating the retrieved security key set using the first obfuscation key.

In an operation S1180, the first HSM build server 400 may build an HSM operating firmware including the obfuscated security key set and distribute the HSM operating firmware in a downloadable form.

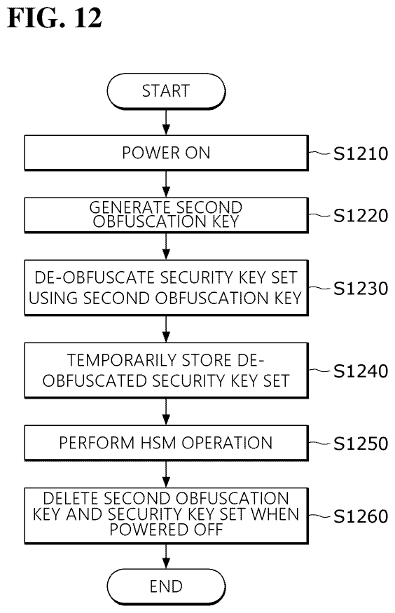

FIG. 12 is a flowchart for describing a method of provisioning a security key for vehicle control by the first vehicle control apparatus 500 according to one embodiment of the present disclosure.

The method of provisioning a security key for vehicle control shown in FIG. 12 may be performed by the second processor 526 of the first vehicle control apparatus 500 or the first HSM 520 built in the first vehicle control apparatus 500, and in FIG. 8, the second processor 526 is described as an example, but the method is not necessarily limited thereto. In addition, the operations of FIG. 12 may be operations after the HSM operating firmware is downloaded, installed, and executed, and the method is not necessarily limited thereto.

Referring to FIG. 12, when the first vehicle control apparatus 500 is powered on in an operation S1210, the second processor 526 may confirm obfuscation information required to generate a second obfuscation key in the second non-volatile memory 522 and generate the second obfuscation key using the confirmed obfuscation information in an operation S1220. Accordingly, in the operation S1220, the second obfuscation key having the same configuration as the first obfuscation key generated in the operation S1160 may be generated.

In an operation S1230, the second processor 526 may de-obfuscate a security key set injected into the HSM operating firmware using the second obfuscation key generated in operation S1220.

In an operation S1240, the second processor 526 may temporarily store the de-obfuscated security key set and the second obfuscation key in the second volatile memory 524.

When booting is completed after the operation S1240, the second processor 526 may perform the operation of the first HSM 520 (e.g., data encryption/decryption, certificate verification, or the like) using the de-obfuscated security key set in an operation S1250.

When a power-off signal is input from the first host 510, the second processor 526 may perform processing to delete the de-obfuscated security key set and the second obfuscation key temporarily stored in the second volatile memory 524 and then terminate the operation of the first HSM 520 in an operation S1260.

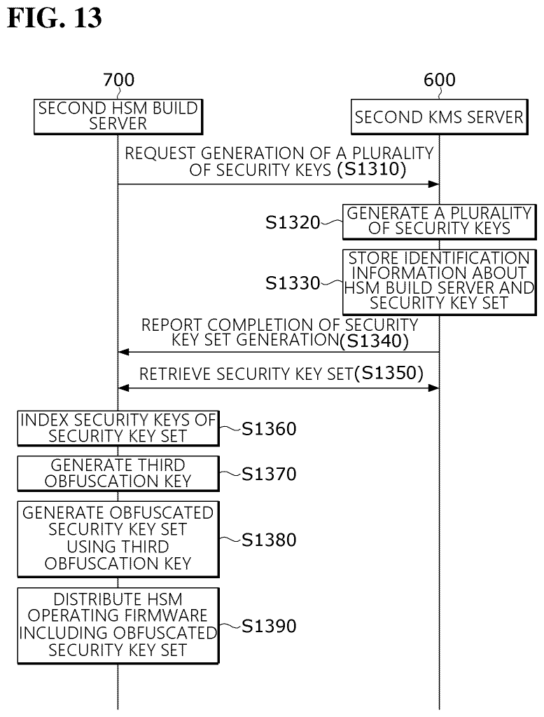

FIG. 13 is a flowchart for describing a method of generating a security key for security key provisioning according to another embodiment of the present disclosure.

Referring to FIG. 13, in an operation S1310, the second HSM build server 700 may request the second KMS server 600 to generate a plurality of security keys to be assigned to the second vehicle control apparatus 800. In the operation S1310, the second HSM build server 700 may request generation of security keys while transmitting identification information about the second HSM build server 700 to the second KMS server 600.

In an operation S1320, the second KMS server 600 may generate a plurality of security keys to be injected into the second vehicle control apparatus 800.

In an operation S1330, the second KMS server 600 may map the identification information about the second HSM build server 700 that has requested generation of security keys and the plurality of generated security keys and store the information and security keys as a security key set.

In an operation S1340, the second KMS server 600 may report to the second HSM build server 700 that the generation of the security key set has been completed.

In an operation S1350, the second HSM build server 700 may retrieve the security key set stored in the second KMS server 600 using the identification information used when requesting the generation of the security keys.

In an operation S1360, the second HSM build server 700 may set indices for the plurality of security keys included in the retrieved security key set and map the indices to identification information about the crypto service for which each security key is to be used. Accordingly, the same index may be mapped to one security key and the crypto service for which the security key is to be used, and the second HSM build server 700 may generate an index list file in which the index is mapped or set for each crypto service in the operation S1360.

In an operation S1370, the second HSM build server 700 may generate a third obfuscation key to obfuscate the plurality of retrieved security keys using the obfuscation information.

In an operation S1380, the second HSM build server 700 may obfuscate each of the retrieved security keys using the generated third obfuscation key and generate an obfuscated security key set by collecting a plurality of obfuscated security keys.

In an operation S1390, the second HSM build server 700 may build and distribute an HSM operating firmware including the obfuscated security key set and an encrypted index list file. The index list file may be encrypted in the operation S1390.

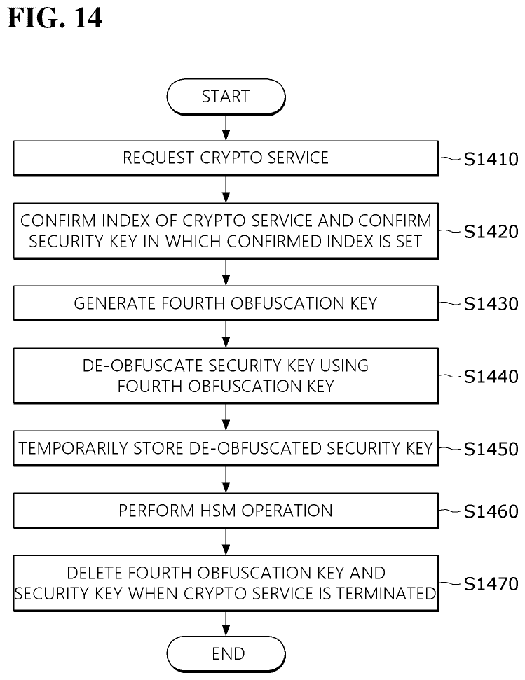

FIG. 14 is a flowchart for describing a method of provisioning a security key for vehicle control by the second vehicle control apparatus 800 according to another embodiment of the present disclosure.

The method of provisioning a security key for vehicle control shown in FIG. 14 may be performed by the fourth processor 826 of the second HSM 820 built in the second vehicle control apparatus 800. In addition, the operations of FIG. 14 may be operations after the HSM operating firmware is downloaded, installed, and executed.

Referring to FIG. 14, when a crypto service request command is input from the second host 810 of the second vehicle control apparatus 800 in an operation S1410, the fourth processor 826 may confirm an index mapped to the requested crypto service in an index list file and confirm a security key in which the confirmed index is set in the fourth non-volatile memory 822 or the HSM operating firmware in an operation S1420.

In an operation S1430, the fourth processor 826 may confirm the obfuscation information required to generate the second obfuscation key in the second non-volatile memory 522 and generate a fourth obfuscation key using the confirmed obfuscation information. Accordingly, in the operation S1430, the fourth obfuscation key having the same configuration as the third obfuscation key generated in the operation S1370 may be generated.

In an operation S1440, the fourth processor 826 may de-obfuscate the security key related to the requested crypto service, i.e., the security key in which the confirmed index is set using the generated fourth obfuscation key.

In an operation S1450, the fourth processor 826 may temporarily store the de-obfuscated security key and the fourth obfuscation key in the fourth volatile memory 824.

In an operation S1460, the fourth processor 826 may perform an operation corresponding to the requested crypto service using the de-obfuscated security key.

In an operation S1470, when the requested crypto service is terminated, the fourth processor 826 may delete the de-obfuscated security key and the fourth obfuscation key stored in the fourth volatile memory 824.

The above-described example methods according to embodiments of the present disclosure are expressed as a series of operations for clarity of description, but it is not intended to limit the order in which the operations are performed, and as needed, each operation may be performed simultaneously or in a different order. In order to implement the methods according to embodiments of the present disclosure, other operations may be included in addition to the described operations, some operations may be excluded and the remaining operations may be included, or some operations may be excluded and additional other operations may be included.

The various embodiments of the present disclosure do not list all possible combinations but are intended to describe representative aspects of the present disclosure, and matters described in the various embodiments may be applied independently or in combination of two or more.

In addition, various embodiments of the present disclosure may be implemented by hardware, firmware, software, or a combination thereof. The hardware may be implemented by one or more application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, or the like.

The scope of the present disclosure includes software or machine-executable instructions (e.g., an operating system, an application, firmware, a program, or the like) that cause operations according to various embodiments to be executed on a device or computer and a non-transitory computer-readable medium having the software or instructions stored thereon and executable on the device or computer.

Example embodiments of the present disclosure are described herein in detail below with reference to the accompanying drawings. While the present disclosure is shown and described in connection with example embodiments thereof, it should be apparent to those having ordinary skill in the art that various modifications can be made without departing from the spirit and scope of the present disclosure.

According to embodiments of the present disclosure, a security key can be safely injected into a vehicle control apparatus during a current mass production process without building separate infrastructure equipment or a separate process for security key provisioning, thereby saving product mass production costs and time and ensuring security of the vehicle control apparatus.

In addition, according to embodiments of the present disclosure, the security of the security key can be ensured and maintained throughout the entire life cycle (e.g., development process and mass production process) of the vehicle control apparatus. Accordingly, embodiments of the present disclosure make it impossible for developers to extract the security key through reverse engineering in both the development process and the mass production process.

In addition, according to embodiments of the present disclosure, since the security key is always stored in an obfuscated state regardless of the stage of developing the vehicle control apparatus, security can be ensured, and an overhead of the vehicle control apparatus can be eliminated by de-obfuscating a relevant security key and allocating the de-obfuscated security key to a random-access memory (RAM) when a crypto service is requested from an application of the vehicle control apparatus. The overhead of the vehicle control apparatus includes, for example, an increased boot time or RAM usage when booting the vehicle control apparatus.

In addition, according to embodiments of the present disclosure, since the same key is used in the development process and the mass production process, it is easy to match encryption/decryption sync performed at a server side. When keys are separated in the development process and the mass production process so that different keys are used, many human errors may occur, such as the security key being out of sync in the development process.

The effects obtainable from the present disclosure are not limited to the effects mentioned above. Other effects not mentioned herein should be clearly understood by those of ordinary skill in the art to which the present disclosure belongs from the above description.

What is claimed is:

1. An apparatus for provisioning a security key for vehicle control, the apparatus comprising:
at least one processor; and
a hardware security module (HSM) including at least one first memory storing at least one program executable by the at least one processor,
wherein the at least one processor is configured to
de-obfuscate an obfuscated security key set included in an HSM operating firmware when powered on, and
store the de-obfuscated security key set in a second memory.

2. The apparatus of claim 1, wherein the at least one processor is configured to delete the de-obfuscated security key set stored in the second memory when a power off command is received.

3. The apparatus of claim 1, wherein the second memory is a volatile memory.

4. The apparatus of claim 1, wherein the at least one processor is configured to communicate with an HSM build server, wherein the HSM build server is configured to generate at least one obfuscation key, obfuscate a security key set using the generated at least one obfuscation key, and inject the obfuscated security key set into the HSM operating firmware.

5. The apparatus of claim 1, wherein the at least one processor is configured to:
generate at least one obfuscation key when powered on; and
de-obfuscate the security key set using the generated at least one obfuscation key.

6. The apparatus of claim 5, wherein the at least one processor is configured to generate an obfuscation key identical to an obfuscation key used when the obfuscated security key set is generated in an HSM build server.

7. An apparatus for provisioning a security key for vehicle control, the apparatus comprising:
at least one processor; and
a hardware security module (HSM) including at least one first memory storing at least one program executable by the at least one processor,
wherein the at least one processor is configured to
de-obfuscate a security key related to a crypto service in an obfuscated security key set included in an HSM operating firmware when the crypto service provided by the HSM is requested after booting, and
store the de-obfuscated security key in a second memory.

8. The apparatus of claim 7, wherein the at least one processor is configured to delete the de-obfuscated security key stored in the second memory when the crypto service is terminated.

9. The apparatus of claim 7, wherein the at least one processor is configured to communicate with an HSM build server, wherein the HSM build server is configured to generate at least one obfuscation key, obfuscate each security key included in a security key set using the generated at least one obfuscation key, and inject the security key set including the obfuscated security keys into the HSM operating firmware.

10. The apparatus of claim 7, wherein the processor is configured to:
generate at least one obfuscation key when the crypto service is requested; and
de-obfuscate a security key related to the crypto service in the security key set using the generated at least one obfuscation key.

11. The apparatus of claim 7, wherein the at least one processor is configured to generate an obfuscation key identical to an obfuscation key used when the obfuscated security key is generated in an HSM build server.

12. A method of provisioning a security key for vehicle control, the method comprising:
de-obfuscating, by at least one processor executing, an obfuscated security key set included in a hardware security module (HSM) operating firmware of an HSM when powered on, wherein the HSM includes at least one first memory storing at least one program executable by the at least one processor; and
storing, by the at least one processor, the de-obfuscated security key set in a second memory.

13. The method of claim 12, further comprising deleting, by the at least one processor, the de-obfuscated security key set stored in the second memory when a power off command is received.

14. The method of claim 12, wherein the second memory is a volatile memory.

15. The method of claim 12, wherein an HSM build server generates at least one obfuscation key, obfuscates a security key set using the generated at least one obfuscation key, and injects the obfuscated security key set into the HSM operating firmware.

16. The method of claim 12, wherein de-obfuscating the security key includes:
generating at least one obfuscation key when powered on; and
de-obfuscating the security key set using the generated at least one obfuscation key.

17. The method of claim 16, wherein generating the obfuscation key includes generating an obfuscation key identical to an obfuscation key used when the obfuscated security key set is generated in an HSM build server.

18. A method of provisioning a security key for vehicle control, the method comprising:
de-obfuscating, by at least one processor, a security key related to a crypto service in an obfuscated security key set included in a hardware security module (HSM) operating firmware when the crypto service provided by an HSM is requested after booting the HSM, wherein the HSM includes at least one first memory storing at least one program executable by the at least one processor; and
storing, by the at least one processor, the de-obfuscated security key in a second memory.

19. The method of claim 18, further comprising deleting, by the at least one processor, the de-obfuscated security key stored in the second memory when the crypto service is terminated.

20. The method of claim 18, wherein an HSM build server generates at least one obfuscation key, obfuscates each security key included in a security key set using the generated at least one obfuscation key, and injects the security key set including the obfuscated security keys into the HSM operating firmware.

21. The method of claim 18, wherein de-obfuscating the security key includes:
generating at least one obfuscation key when the crypto service is requested; and
de-obfuscating a security key related to the crypto service in the security key set using the generated at least one obfuscation key.

22. The method of claim 21, wherein generating the obfuscation key includes generating an obfuscation key identical to an obfuscation key used when the obfuscated security key is generated in an HSM build server.
